(19) United States
(12) Patent Application Publication
(10) Pub. No.: US 2010/0074422 A1
(43) Pub. Date: Mar. 25, 2010

(54) SETTING SELECTED ANNOUNCEMENTS CONCERNING USERS OF COMMUNICATION EQUIPMENT INTO A MESSAGING SERVER OF A NETWORK OPERATOR

(75) Inventor: Marc Bellanger, Vienna (AT)

Correspondence Address: HOGAN & HARTSON LLP, ONE TABOR CENTER, SUITE 1500, 1200 SEVENTEENTH ST, DENVER, CO, 80202, US

(73) Assignee: NXP B.V., Eindhoven (NL)

(21) Appl. No.: 12/439,158

(22) PCT Filed: Aug. 3, 2007
(86) PCT No.: PCT/IB2007/053058

§ 371 Date: Nov. 6, 2009

(30) Foreign Application Priority Data
Aug. 31, 2006 (EP) 06300908.8

(51) Int. Cl. H04M 1/64

(52) U.S. Cl. 379/88.22

(57) ABSTRACT

An announcement managing device for communication equipment includes a method recording means arranged for storing data within the communication equipment which is representative of successive actions carried out by a user for accessing the messaging server to record an announcement, and for storing timings between these successive actions, the data and the corresponding timings defining a method. The announcement managing device also includes a managing means which when triggered by a dedicated action, is operable for providing a list of titles respectively associated with recorded announcements on a display means of the communication equipment so that a user can select a title.

### CROSS-REFERENCE TO RELATED APPLICATIONS

The present application relates to and claims the benefit of and priority to PCT Application No. PCT/IB2007/053058 filed Aug. 3, 2007 which claims priority to European Patent Application No. EP 06300908.8 filed Aug. 31, 2006, both of which applications are hereby incorporated by reference in their entireties for all purposes as if fully set forth herein.

### BACKGROUND OF THE INVENTION

1. Field of the Invention

The present invention relates to communication equipment and more precisely to the recording of announcements (or messages) concerning the users of such communication equipment into a messaging server of a network operator.

2. Relevant Background

Today, a user/caller of a communication device can record an announcement or message into a messaging server provided by the communication device's network operator in order for this announcement to be automatically transmitted to another user/caller when they are unavailable. This announcement is queued to be sent to a caller when the user does not want to be disturbed (turns the device off) or cannot be reached due to lack of network availability. Such a recording is useful when a user is in a meeting, on vacation, or abroad (possibly with a time shifting), for instance.

For the purposes of the present invention “communication equipment” means any piece of equipment, possibly of the mobile or portable type, capable of exchanging data with another piece of equipment. Accordingly a piece of communication equipment may be a fixed or mobile telephone, a (personal) computer, a laptop or a personal digital assistant, for instance.

Moreover, for the purposes of the present invention a “messaging server” means any type of server capable of storing and transmitting any type of announcement or message concerning users of such communication equipment. So, an announcement may be associated with a voice mailbox, a video mailbox for 3G or an e-mail server, for instance.

A user forming an announcement can record into a messaging server a message asking for a caller to leave a message. Generally the message server allows only one type of announcement to be recorded at once. And, in the alternative the user can use a possibly predefined generic announcement. In both case the announcement provided to a caller by a message server for an unavailable user does not give to the caller any information regarding the availability of the person he tries to contact.

In order to improve the situation, it has been proposed, in U.S. Patent Application Publication No.: US 2005/0089149, to allow a user to store several different types of announcements in a messaging server. Then when a user desires to connect with a caller the user can select one announcement and transmits it to the caller. This patent document also proposes putting the caller in a stand by mode so that the called user has time at his disposal for generating an reply dedicated to the caller.

With such an improvement a user has to just select one announcement in his list of predefined announcements as needed and transmit it to the desired recipient. But these announcements are stored in the messaging server and each time the user wants to select one of his announcements he has to carry out several successive actions (steps) to reach the messaging server, select an announcement for transmission, and to then leave the messaging server. Moreover, this solution requires to adapt the messaging server for each operator in order to store the list of predefined announcements of each of its user clients and to furthermore allow the latter to proceed to their announcement selections. That forces the user equipment and the messaging server not only to be compatible according to a established protocols, but also to carry out any network modifications.

### BRIEF SUMMARY OF THE INVENTION

One object of the present invention is to offer improvments over the prior art and notably to allow each user of a communication device to schedule and easily change his announcements depending on the circumstances without inducing any modifications of the network provider's messaging server.

According to one embodiment of the present invention an announcement managing device for a piece of communication equipment, said device associated with a messaging server of an operator, wherein the device includes:
a method recording means arranged for storing i) data representative of the successive actions that a user has to carry out with his communication equipment for accessing the messaging server, for recording and storing an announcement and for leaving the messaging server, and ii) elapsed time periods between these successive actions, the data and time periods defining a method associated to the messaging server, and
a managing means arranged, when it is triggered by a dedicated action, for providing a list of titles, respectively associated to stored announcements, on a display means of his communication equipment enabling the user to select a title, and for carrying out a recorded method associated with the messaging server of the user's operator in order to record and store the announcement associated to this selected title in this messaging server.

One skilled in the art will recognize that a messaging server of the use's operator is a messaging server associated with a network service provider. A network service provider is a business or organization that sells bandwidth or network access by providing direct backbone access to the Internet or communication network and usually access to its network access points. For such a reason, network service providers are sometimes referred to as backbone providers. Network service providers may consist of telecommunications companies, data carriers, wireless communications providers, Internet service providers, and cable television operators offering high-speed Internet access. The announcement managing device according to the present invention can include additional characteristics considered separately or combined, and notably:
it may comprise an announcement recording means arranged for storing an announcement associated to a title, provided by the user by means of his communication equipment, into a list;
   the announcement recording means may be arranged for determining the duration of an announcement and for storing this duration in correspondence with the title associated to the announcement;
   the announcement recording means may be arranged for storing the announcements into a memory means of its communication equipment;
the stored data may be Dual Tone Multi-Frequency (DTMF) associated to keys of a keyboard of a human-machine interface of the communication equipment;
its managing means may be arranged for being scheduled in order to automatically replace a first announcement recorded in the messaging server with a second announcement selected at a chosen time;
   its managing means may be arranged for being scheduled in order to automatically replace a first announcement recorded into the messaging server with a second announcement selected at a chosen time and during a chosen time interval, and for replacing this second announcement recorded into the messaging server with the first announcement when the time interval is expired;
   in a variant of the previous managing means, when a second announcement is associated with a title only representative of an event with a duration smaller than a day, its managing means may be arranged for replacing the second announcement recorded into the messaging server with the first announcement the day after the event occurred, when the user has not yet triggered this replacement.

The invention also provides a piece of communication equipment comprising an announcement managing device such as the one above introduced.

Such a communication equipment may also comprise a diary means arranged for being scheduled by the user to signal events that can be associated to a title, and for triggering the announcement managing device with a title associated with a starting event so that its managing means carries out the associated recorded method to the user's operator's messaging server in order to record the announcement associated to this selected title in this messaging server.

In another embodiment of the present invention, the piece of communication equipment may comprise a diary means arranged for being scheduled by the user to signal events, and for triggering the announcement managing device when a scheduled event is starting so that its managing means provides a list of titles, respectively associated to stored announcements, on a display means to allow the user to select one title, and then for carrying out the recorded method associated to the messaging server of the user's operator in order to record the announcement associated to this selected title in this messaging server.

Moreover, the diary means may be arranged for triggering the announcement managing device when a scheduled event is finished, in order its managing means replaces the announcement recorded into the messaging server with another announcement (for instance the one which was recorded into the messaging server before the beginning of the scheduled event).

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 schematically and functionally illustrates a radio communication network to which are connected a messaging server and mobile communication equipments according to the invention,

FIG. 2 schematically and functionally illustrates a mobile communication equipment comprising an example of embodiment of an announcement managing device according to the invention.

The appended drawings may not only serve to complete the invention, but also to contribute to its definition, if need be. The appended drawings may not only serve to complete the invention, but also to contribute to its definition, if need be. One skilled in the art will readily recognize from the following discussion that alternative embodiments of the structures and methods illustrated herein may be employed without departing from the principles of the invention described herein.

### DETAILED DESCRIPTION OF THE INVENTION

Specific embodiments of the present invention are hereafter described in detail with reference to the appended Figures. Like elements in the various Figures are identified by like reference numerals for consistency. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

One focus of the present invention aims at allowing users of communication equipment connected to the communication network of an operator (provider) to schedule and easily change announcements (or messages) located on the operator's messaging server.

In the following description it will be considered that the communication network is a mobile (or cellular) network, such as a Universal Mobile Telecommunications System (“UMTS”) network. But as one skilled in the relevant art will recognize, the invention is not limited to this type of mobile (or cellular) network as it can apply to any type of communication network, mobile or not, which offers an access to a messaging server to its clients.

Moreover, given the example of communication network (UMTS) chosen to illustrate an implementation of the invention, it will be considered in the following description that the communication equipment are mobile (or cellular) telephones. Again the invention is not limited to this type of communication equipment but rather applies to any type of communication equipment, mobile (or portable or cellular) or not, and capable of exchanging data with another communication equipment. So, it may be a fixed or mobile telephone, a (personal) computer, a laptop or a personal digital assistant, for instance.

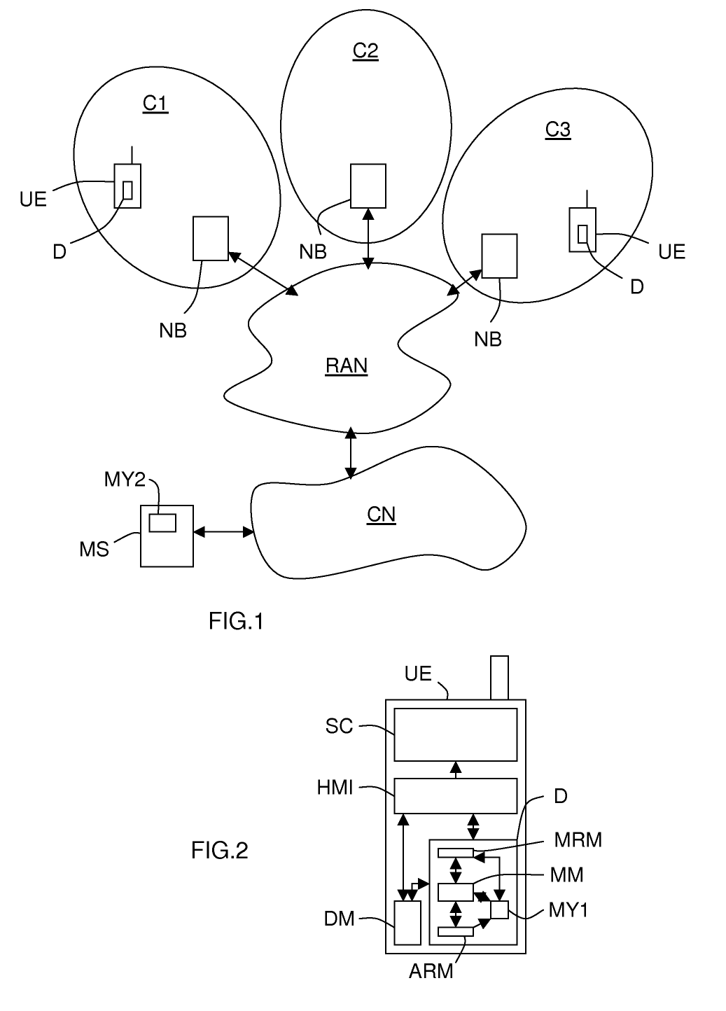

As it is illustrated in FIG. 1, in a schematically manner but nevertheless sufficient to understand the invention, a UMTS network can be summed up to a core Network (“CN”)110 coupled to a Radio Access Network (“RAN”) 120 (or UTRAN).

The radio access network 120 mainly comprises base stations (called Node Bs) 125 and radio network controllers or RNCs (not illustrated), connected therebetween.

Each Node B 125 is associated to at least one (logical) cell Ci 130 (here i=1 to 3, but it can take any value greater than 0) covering a radio area in which mobile telephones UE 140 can establish (or follow) radio communication. Each radio network controller is associated to at least one cell Ci 130, and therefore is coupled to at least one Node B 125.

The core network 110 comprises network equipments which, for some of them, are notably connected to the radio network controllers. Among these network equipments one may notably mentioned the MSC (“Mobile Switch Center”) to which a messaging server (“MS”) 150 can be connected in an UMTS network.

Only one messaging server 150 has been sketched in FIG. 1. But, generally each operator of a communication network is associated to at least one messaging server and generally includes several messaging servers 150.

In the following description it will be considered that the messaging server is a voice mailbox. But as one skilled in the relevant art will recognize, the invention is not limited to this type of messaging server as it applies to any type of messaging server capable of storing any type of announcement or message concerning users of communication equipment (here mobile telephone). Accordingly, a messaging server may be also an e-mail server or a video mailbox for 3G, for instance.

According to one embodiment of the present invention an announcement managing device D 170 is installed into the communication equipment 140.

As schematically and functionally illustrated in FIG. 2, an announcement managing device D 140 according to one embodiment of the present invention comprises, in combination, at least a method recording module 210 MRM and a managing module 220 MM.

The method recording module 210 is operable for storing data which are representative of the group of successive actions that a user must carry out with its mobile telephone 140 when he wants to access to the messaging server 150 for recording an announcement (or message), and for leaving this messaging server 150 until he hangs up his mobile telephone 140. The method recording module 210 is also operable for estimating and storing the timings between these successive actions.

For the purposes of this example of the present invention the term “method” refers to the data and the corresponding timings which together represent a group of successive actions carried out by a user with his mobile telephone for recording an announcement in a messaging server. Such a method is associated to a chosen messaging server. One skilled in the relevant art will recognize that a messaging server may be possibly shared by several operators.

In order to record (store) such a method, the user must carry out a recording phase. For this purpose the user has to select a dedicated item in a menu displayed onto the screen 230 (or display means) SC of his mobile telephone 140, by means of the keys of its human-machine interface HMI 280. Then, according to one embodiment of the present invention, the method recording module 210 invites the user to start to record a method, i.e. to access to the messaging server MS of his operator for recording an announcement. The user dials the communication number of the messaging server 150 (here a voice mailbox) by means of the keys of his mobile telephone 140.

It is important to note that the method recording module 210 stores data representing each action carried out by the user with the keys of his mobile telephone 140, after the starting invite message of the recording phase. For this purpose, the method recording module 210 can store the DTMF (“Dual Tone Multi-Frequency”) that is associated to each key of the keyboard of the human-machine interface HMI 280. Of course, the method recording module 210 also stores the dialed number of the messaging server 150, and the timing between each successive action in order to be able to reproduce an announcement recording at the messaging server MS at a later time.

When the communication has been established between the mobile telephone 140 and the messaging server 150, the user is invited to start a typical announcement recording. To do so the user browses the announcement recording menu of the messaging server 150 with the keys of his mobile telephone 140 until the user is invited to provide his announcement. At this stage, the method recording module 210 preferably displays, on the screen 230, a list of announcements (and more preferably titles representing these announcements), which are stored into a memory 240 MY1 of the mobile telephone 140. This list can be handle by the mobile telephone 140 through a file system, for example. This memory 240 can be part of a device 250, as illustrated in FIG. 2. Thereafter, the user selects an announcement in the list.

The aim of the previously described method recording phase is to determine a group of successive actions carried out by a user. The data defining the announcement selected by the user are not necessarily sent to the messaging server 150 for storage in a memory 180 MY2 it comprises, in correspondence with the communication identifier of the mobile telephone UE. Indeed, the announcement selection by the user is only intended for indicating to the method recording module 210 the timing at which it will have to provide the messaging server 150 with data defining a selected announcement and when the recorded method will be replayed by the managing module 220.

Next, the user confirms the announcement recording at the messaging server 150 and ends the communication with this messaging server 150 by means of the dedicated keys HMI 280 of the mobile telephone 140. Then the method recording module 210 saves the recorded method, for instance, but not necessarily, into the memory 240 housed within the mobile telephone 140.

The managing module 220 intervenes when a method has been previously recorded by the method recording module 210. This intervention occurs each time the managing module 220 is triggered by a dedicated action, possibly carried out by the user, in order to select an announcement to be played by the messaging server 150 and proposed by a dedicated item of the menu.

More precisely, when the managing module 220 is triggered, it displays the list of announcement titles (stored in the device memory 240) on the screen 230 of the mobile telephone 140 for user selection of a title. Upon selection the managing module 220 carries out (or reproduces) the recorded method which is associated with the messaging server 150 of the user's operator in order to record in the messaging server 150 the announcement associated with this selected title.

In other words, the managing module 220 reproduces (or replays) the successive actions or the group of successive actions that defines the recorded method. When an action consists of dialing the messaging server's communication number at a time defined by the recorded method, the managing module 220 may issue an order to the mobile telephone 140 to dial this communication number to establish a communication link with the messaging server 140. When an action comprises providing the messaging server 150 with data defining the announcement selected by the user at a time defined by the recorded method, the managing module 220 can access to the device memory 240 to extract the announcement data and can issue an order directing the mobile telephone 140 to send the data to the messaging server 150 for storage in the messaging server's memory 180. The stored data is associated with the communication identifier of the mobile telephone 14 to enable this announcement to be played when required/requested.

When the last action (step) of the recorded method has been replayed by the managing module 220 and the announcement recording process at the messaging server 150 is finished the managing module 220 can, for example, display a message on the screen 230 of the mobile telephone 140 to inform its user that the announcement recording has been correctly carried out. Therefore, each time the mobile telephone 140 receives an incoming call from a caller, the messaging server 150 will automatically transmit the recorded announcement to this caller and subsequently notify the user that an announcement has been sent to the caller.

One will notice that when the mobile telephone 140 replays the recorded method, the mobile telephone 140 is preferably available for any action input by the user (and an idle screen can be displayed). A message can inform the user that the announcement recording is in progress and that a mobile originated call will discard or cancel the issuance of the announcement recording. Moreover, when the mobile telephone 140 receives notification that a mobile call was terminated while the recorded method is running, a message can be displayed at the end of the call to inform the user that the recorded method failed and will be retried because the announcement recording has been stopped during the call. Moreover, one skilled in the relevant art will recognize that a time limit can be imposed for replaying the recorded method to prevent an infinite call (loop) in the case of application failure (for instance this time limit may be equal to 2 or 3 minutes).

The device 250 can also, according to another embodiment of the present invention, comprise an announcement recording module 260 ARM intended for recording and storing data defining announcements associated to titles in the device memory 240.

The announcement recording module 260 intervenes each time it is triggered by a dedicated action carried out by the user, so as to record a new announcement, as proposed by a dedicated item on the menu. More precisely, when the announcement recording module 260 is triggered it displays a message on the screen 230 of the mobile telephone 140 in order to invite the user to provide a new announcement. For example, the user can be invited to talk into the microphone of the mobile telephone 140. At the end of the announcement, the announcement recording module 260 displays a message on the screen 230 of the mobile telephone 140 to invite the user to select an item dedicated to identify the “end of announcement”. Then, the announcement recording module 260 displays a message on the screen 230 of the mobile telephone 140 to invite the user to associate a title to his new announcement. For example, the user may be invited to talk into the microphone to provide it with a title. In another embodiment of the present invention the user may be invited to enter the title with the keys while in another embodiment the user may be invited to select a title amongst a predefined list of titles displayed by the announcement recording module 260 on the screen 230.

Any title may be associated with a new announcement. For instance, a title may signal a meeting (“meeting lasting 1 hour”, “meeting lasting 3 hours”, “meeting occurring in the morning”), or a vacation (“vacation lasting one week”, “vacation lasting one month”), or a travel abroad, possibly with a time shifting (“time shifting in India”).

When the announcement recording module 260 has been provided with the data defining a new announcement and its corresponding title, the announcement recording module 260 stores these data in the device internal memory 240. At that time the new announcement belongs to the list of announcements which are now at the user's disposal in his mobile telephone 140.

The announcement recording module 260 can be also configured to determine the duration of a new announcement and to store data representing this duration, in correspondence with the title associated to the new announcement, in the device memory 240. The duration of an announcement may be displayed with the corresponding announcement title to inform the user of its duration during selection. In some specific implementations the duration of an announcement may also be useful for the managing module 220 when it replays the actions defining a recorded method.

It is important to note that the managing module 220 can be scheduled to automatically replace an announcement that has been recorded into the messaging server 150 with another announcement belonging to the list of announcements stored into the device's memory 240. This replacement can occur at a chosen time or any time (or event) specified by the user.

In this case, when the user selects an announcement he wants to be played by the messaging server 150, the managing module 220 can invite him through a message displayed on the screen 230 of his mobile telephone 140 to provide the managing module 220 with the time at which he wants the selected announcement to replace the current message. In other words, a displayed message can invite the user to define how long he wants a selected announcement to be active and when the message is to become active.

The managing module 220 is also operable to automatically replace an announcement recorded into the messaging server 150 after a chosen duration (or time interval), with another announcement belonging to the list of announcements stored into the device memory 240.

This function is intended for avoiding a situation in which an announcement continues to be played by the messaging server 150 while the event for which it has been selected is finished. Indeed, it often occurs that a user forgets to deactivate an announcement that was previously activated on the messaging server 150 for signaling a special event to the callers.

In this case, when the user selects an announcement that is desired to be played by the messaging server 150, the managing module 220 can invite the user, through a message displayed on the screen 230 of his mobile telephone 140, to provide the managing module 220 with a time at which the selected announcement is to be replaced with another announcement (for instance the preceding one), or with the length of time (duration) of the event for which the selected announcement is associated.

Therefore, according to one embodiment of the present invention when the time duration associated with the announcement has expired, the managing module 220 automatically replaces the (second and selected) announcement recorded at the messaging server 150 with a (first) announcement of the list of announcements (for instance the one who was recorded before the second one).

In a variation of the previous example, some announcements may be associated with a title that is representative of an event having a duration smaller than a day. For this purpose, a dedicated flag may be associated with a new announcement by the announcement recording module 260 at the end of the recording of this new announcement. In this case, when the managing module 220 replaces a (first) announcement recorded in the messaging server 150 with another (second and selected) announcement, (the second announcement being recorded in the messaging server 150 during a chosen duration) a flag associated with the title of this second announcement informs the managing module 220 that this second announcement will be replaced with the first announcement the day after the event of interest occurs, assuming the user has not yet triggered the replacement himself.

Therefore, the managing module 220 automatically cancels the replacement of the first announcement the day after the replacement announcement was selected.

The device 250 within the communication apparatus 140, according to one embodiment of the present invention can be also triggered and/or scheduled by a diary module 270 of its mobile telephone 140.

Recall that a diary module 270 can be scheduled by a user in order to signal events and possibly to trigger an action in another module of its mobile telephone 140. So, according to one embodiment of the present invention the diary module 270 is used for triggering the announcement managing device 250 with a title that the user has previously associated with a scheduled event.

For this purpose, when the diary module 270 is used by the user to schedule an event, it can display a message on the screen 230 of the mobile telephone 140 to invite the user to associate an announcement to this event. When the user agrees, the diary module 270 retrieves from the device 250 the list of announcement titles that are stored into its internal memory 240, and displays this list onto the screen 230 so that the user can select one of them. Then, the diary module 270 stores the data representative of this scheduled event (at least the starting time and the event definition, and possibly the ending time) in correspondence with data representative of the selected announcement.

When the starting time of such a scheduled event is reached, the diary module 270 orders the device 250 with its managing module 220 to retrieve the recorded method associated with the announcement from memory 240. Then the managing module 220 starts to replay the recorded method, as described above, in order to record (send) the announcement, designated by the diary module 270, to the messaging server 150.

In the same manner, when the ending time of such a scheduled event is reached, the diary module 270 orders to the device 250 to replace the last recorded announcement with another announcement (for instance the previous recorded announcement). Upon receipt of the instructions, the managing module 220 replaces the last recorded announcement with the other (previous) one, as described above, in order to again place the pervious announcement once again at the messaging server 150.

The announcement managing device 250 and the diary module 270 may, in one embodiment of the present invention, be implemented in the form of software modules. But, as one skilled in the relevant art will recognize, each of them may be also realized with a combination of hardware, firmware and software modules, or only with hardware (for instance, each of them may be at least a part of an integrated circuit (IC) realized in CMOS technology or in any technology currently used in chip factory).

The invention is not limited to the embodiments of announcement managing device and communication equipment described above, only as examples, but it encompasses all alternative embodiments which may be considered by one skilled in the art within the scope of the claims hereafter.

1-14. (canceled)

15. An announcement managing device for use with communication equipment communicatively coupled to a messaging server of a network operator, the device comprising:
a method recording means operable for storing data representative of successive actions carried out by said communication equipment for accessing said messaging server, recording an announcement and storing said announcement, and time intervals between said successive actions, said data and said time intervals defining a recorded method associated with said messaging server; and
a managing means operable, when triggered by a dedicated action, for providing a list of titles, respectively associated with said stored announcements, on a display means of said communication equipment and for carrying out the recorded method associated with the messaging server so as to record at said messaging server an announcement associated with a selected title.

16. The announcement managing device according to claim 15, further comprising an announcement recording means operable for storing on a list said announcement associated to said selected title.

17. The announcement managing device according to claim 16 wherein said announcement recording means is operable for determining the duration of an announcement and for storing said duration in correspondence with the title associated with said announcement.

18. The announcement managing device according to claim 16, wherein said announcement recording means is operable for storing said announcement into a memory means of said communication equipment.

19. The announcement managing device according to claim 15 wherein said stored data are Dual Tone Multi-Frequency (DTMF) tones associated with keys of a keyboard of a human-machine interface of said communication equipment.

20. The announcement managing device according to claim 15 wherein said managing means is operable for being scheduled to automatically replace, at a chosen time, a first announcement recorded in said messaging server with a second selected announcement.

21. The announcement managing device according to claim 20 wherein said second announcement is associated with a title representative of an event having a finite duration and said managing means is operable for automatically replacing said second announcement with said first announcement upon expiration of said finite duration.

22. The announcement managing device according to claim 1 wherein said managing means is operable for being scheduled to automatically replace, at a chosen time, a first announcement recorded in said messaging server with a second selected announcement and for, upon expiration of a chosen time interval, replacing said second announcement recorded in said messaging server with said first announcement.

23. A communication apparatus comprising:
a display screen;
a user interface; and
an announcement managing device, said announcement management device communicatively coupled to said display screen and said user interface and wherein said announcement management device includes
a memory,
a method recording module operable for storing on said memory data representative of successive actions for accessing a messaging server, recording an announcement and for storing said announcement, and for storing on said memory time intervals between said successive actions, said data and said time intervals defining a recorded method associated with said messaging server,
a managing module operable for providing a list of titles, respectively associated with said stored announcements, on the display screen and for carrying out the recorded method associated with a selected title, and
an announcement recording module operable for recording said announcement.

24. The communication apparatus of claim 23 wherein said announcement recording module is operable for determining the duration of said announcement and for storing said duration in correspondence with the title associated with said announcement.

25. The communication apparatus according to claim 23 further comprising a diary module communicatively coupled to said announcement managing device and said user interface, said diary module operable to signal an event associated with a title, and for triggering said announcement managing device with said title associated with said event to direct the managing module to carry out the recorded method associated with the title at the messaging server so as to record the announcement associated with the title at said messaging server.

26. The communication apparatus according to claim 23 further comprising a diary module communicatively coupled to said announcement managing device and said user interface, said diary module operable for being scheduled by a user to signal an event, and responsive to occurrence of said event, for triggering said announcement managing device to direct the managing module to provide a list of titles respectively associated with stored announcements for display on said display device, and responsive to said user selecting one title, carrying out the recorded method associated with said selected title to record the announcement associated with said selected title in said messaging server.

27. The communication apparatus according to claim 26 wherein said diary means is operable to cause said announcement managing device to replace said announcement recorded in said messaging server with another announcement responsive to the completion of the event.

28. The communication equipment according to claim 27 wherein said another announcement is an announcement that was recorded to said messaging server before said event occurred.
